(19) United States
(12) Patent Application Publication
(10) Pub. No.: US 2024/0382979 A1
(43) Pub. Date: Nov. 21, 2024

(54) FLUID FILLING NOZZLE

(71) Applicants: Hyundai Motor Company, Seoul (KR); Kia Corporation, Seoul (KR)

(72) Inventors: Ji Hoon Lee, Uiwang-Si (KR); Jun Ho Jang, Seongnam-Si (KR); Han Eol Song, Seongnam-Si (KR)

(21) Appl. No.: 18/387,579

(22) Filed: Nov. 7, 2023

(30) Foreign Application Priority Data
May 17, 2023 (KR) 10-2023-0063862

(51) Int. Cl. B05B 1/00; B05B 9/01; B05B 11/00

(52) U.S. Cl. CPC B05B 1/005; B05B 9/01; B05B 11/0032

(57) ABSTRACT

A fluid filling nozzle may include a nozzle part configured to guide a fluid from an interior thereof along a reference direction, a rotation part coupled to a side of the nozzle part in the reference direction such that an end thereof in an opposite direction to the reference direction is rotatable, and a guide part, in which the nozzle part is disposed in an interior thereof, and that is configure to guide the nozzle part to move parallel or antiparallel to the reference direction. The guide part May be configured to engage a portion of the rotation part such that the rotation part is rotated if the guide part is moved parallel or antiparallel to the reference direction.

### CROSS-REFERENCE TO RELATED APPLICATION

This application claims the benefit of priority to Korean Patent Application No. 10-2023-0063862, filed in the Korean Intellectual Property Office on May 17, 2023, the entire contents of which are incorporated herein by reference.

### TECHNICAL FIELD

The present disclosure relates to a fluid filling nozzle.

### BACKGROUND

A hydrogen fuel cell electric vehicle (FCEV) electrochemically generates electricity for its power source by converting chemical energy of oxygen and hydrogen in a fuel into electric energy. The hydrogen fuel cell electric vehicle may continuously generate electric power regardless of a capacity of a fuel cell by supplying a fuel (e.g., hydrogen) and air from an outside. Thus, the hydrogen fuel cell electric vehicle may rarely discharge contaminants while exhibiting high efficiency.

To charge a hydrogen gas in a vehicle, a high-pressure gas may be supplied while a gas filling nozzle provided in a gas charging device is coupled and connected to a receptacle provided in the vehicle. Then, because the hydrogen gas is cooled to about −40 degrees C. and is injected into an interior of the vehicle in a cryogenic state, ice may be formed between a nozzle and/or a receptacle for the hydrogen due to moisture in air when the air contacts an outer surface of the nozzle. Accordingly, the nozzle may be stuck and/or fail to release for a period of time due to ice even though filling is completed.

### SUMMARY

The following summary presents a simplified summary of certain features. The summary is not an extensive overview and is not intended to identify key or critical elements.

Systems, apparatuses, and methods are described for a fluid filling nozzle. A fluid filling nozzle may comprise a nozzle configured to direct a fluid from an interior of the nozzle along a reference direction; a rotation part coupled to a side of the nozzle so as to be able to rotate around the nozzle while coupled thereto; and a guide surrounding the nozzle and configured to guide the nozzle to move parallel or antiparallel to the reference direction. The guide may be configured to engage with a portion of the rotation part so as to cause the rotation part to be rotated based on the guide being moved forwards or rearwards.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a fluid filling nozzle according to a first example of the present disclosure;

FIG. 2 is a view illustrating a state in which the fluid filling nozzle of FIG. 1 is separated from a receptacle;

FIG. 3 is a view illustrating a state in which a protruding member is disposed a third hole area;

FIG. 4 is a view illustrating a state, in which a protruding member is disposed in a second hole area;

FIG. 5 is a view illustrating a cross-section of a fluid filling nozzle taken along a plane that is perpendicular to a reference direction according to a first example of the present disclosure;

FIG. 6 is a view illustrating a fluid filling nozzle according to a second example of the present disclosure;

FIG. 7 is a view illustrating a fluid filling nozzle according to a third example of the present disclosure; and

FIG. 8 is a view illustrating a fluid filling nozzle according to a fourth example of the present disclosure.

### DETAILED DESCRIPTION

Hereinafter, some examples of the present disclosure will be described in detail with reference to the accompanying drawings. Same components are denoted by the same reference numerals throughout the description and drawings. A detailed description of components and related configurations and functions have already been described and/or are generally known will be omitted if such a detailed description will make understanding of the examples of the present disclosure unclear.

A fluid filling nozzle according to the present disclosure may be a fluid filling nozzle any fluid filling nozzle, and is not limited to the examples provided for explaining the concepts in this disclosure (e.g., for providing hydrogen fuel). For example, the hydrogen filling nozzle may be used for a transportation means (e.g., vehicle) that uses a fuel cell having a fuel cell mounted thereon and/or attached thereto. The transportation means (e.g., vehicle) may comprise, for example, a vehicle, an aircraft, an urban air mobility (UAM), a short-range mobile aircraft, and/or a ship.

The fluid may be hydrogen, as discussed in the examples herein. However, the fluid is not limited thereto. Any fluid that may be provided to a receptacle R via a nozzle (e.g., as disclosed herein) may be considered.

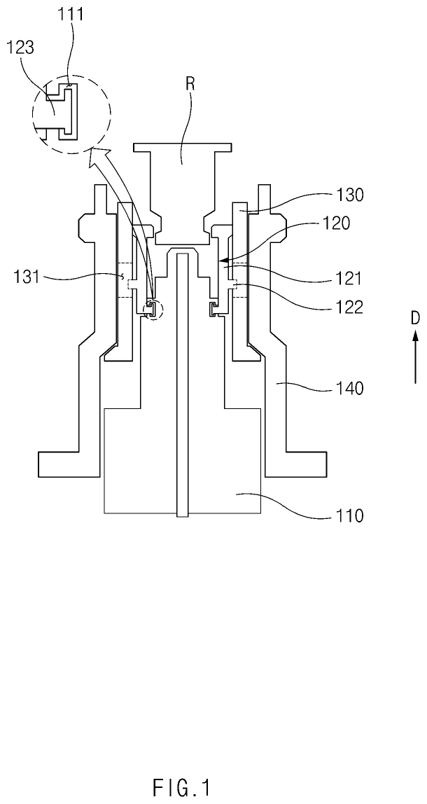

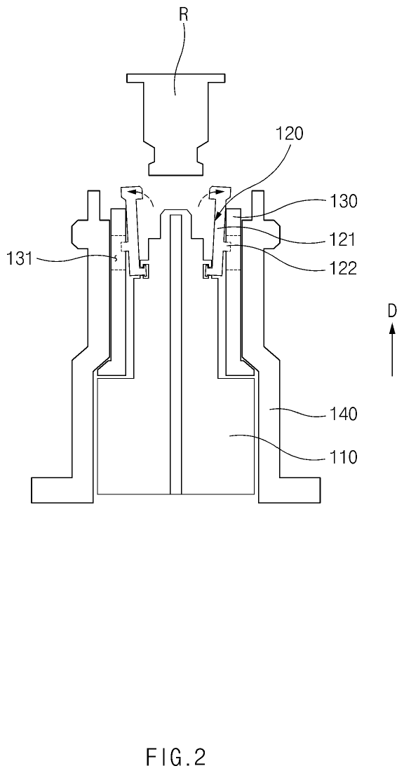

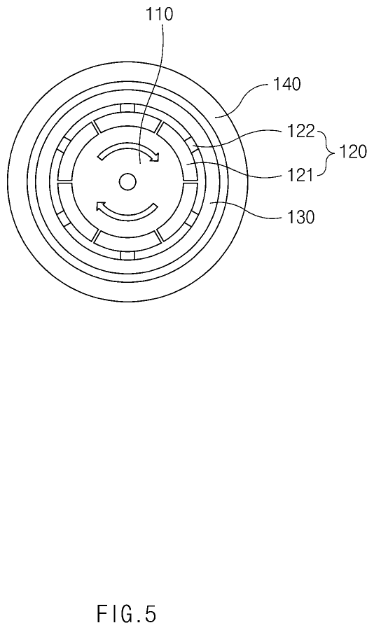

FIG. 1 is a view illustrating a fluid filling nozzle according to a first example of the present disclosure. FIG. 2 is a view illustrating a state, in which the fluid filling nozzle of FIG. 1 is separated from a nozzle. FIG. 5 is a view illustrating a cross-section of the fluid filling nozzle, taken along a plane that is perpendicular to a reference direction according to the first example of the present disclosure.

The fluid filling nozzle according to the first example of the present disclosure may include a nozzle part 110 (e.g., a nozzle), a rotation part 120, and a guide part 130 (e.g., a guide). The nozzle part 110 may be configured to guide (e.g., direct, etc.) a fluid that is introduced into an interior thereof, e.g., along a reference direction D. The reference direction D may be a direction in which the fluid is injected to a vehicle, for example. With reference to FIG. 1, the reference direction D is an upward direction.

The rotation part 120 may be coupled to a side of the nozzle part 110 (e.g., in the reference direction D). The rotation part 120 may be coupled to the side of the nozzle part 110 in via a coupling so as to be rotatable in a rotation direction around the reference direction D. For example, an end of the rotation part 120 may be rotatably coupled to the side of the nozzle part so as to be rotatable around the nozzle part 110 in the rotation direction (perpendicular to the reference direction D). The rotation part 120 may be configured to engage the fluid filling nozzle with the receptacle R (e.g., to allow acceptance, interlocking, reception of the receptacle R by the nozzle part 110.

The rotation part 120 may be rotatably coupled to the nozzle part 110 via a protrusion 123 (e.g., a first protrusion) configured to be inserted into a groove 111 formed in the nozzle part 110. The protrusion 123 may be at an end of the rotation part 120 (e.g., an opposite to the direction D). A length of the groove along the reference direction D may be formed to be larger than a length of the protrusion 123 of the rotation part 120. Because the length of the groove along the reference direction D is formed to be larger than the length of the protrusion 123, the rotation part 120 may be rotated with the protrusion 123 as a rotation center within a marginal space range of the groove 111.

The nozzle part 110 may be disposed in an interior of the guide part 130. The guide part 130 may guide the nozzle part 110 such that the nozzle part 110 is moved parallel to the reference direction D (e.g., along and/or in the opposite direction thereto). The guide part 130 configured to engage with a portion of the rotation part 120.

A radial direction and a circumferential direction are defined with respect to the reference direction D. The radial direction and the circumferential direction are defined with respect to an imaginary circle formed in a plane perpendicular to (e.g., having a perpendicular central axis that extends parallel to) the reference direction D. The radial direction may be a direction along a radius of the imaginary circle. The circumferential direction may be a direction parallel to a circumference of the imaginary circle.

The rotation part 120 may be configured such that the protrusion 123 is moved along the circumferential direction if the guide part 130 is moved in the opposite direction to the reference direction D. In this way, linear movement of the guide part 130 may cause and/or expedite rotation of the rotation part 120. The rotation may disrupt (e.g., crack, crush, displace, melt) ice generated between the receptacle R and the nozzle (e.g., during fueling).

Because the rotation part 120 is rotated via the linear movement of the guide part 130 and ice may be disrupted by the rotation, the ice (e.g., generated in the fluid filling process) may be more easily disrupted via the rotation movement as compared with the case in which ice is disrupted simply through the linear movement (e.g., if the nozzle part 110 were simply pulled away from the receptacle R). Hereinafter, shapes of the components that permit the operation will be described in detail.

The rotation part 120 may include a rotation member 121 and a protruding member 122 (e.g., a second protrusion). The rotation member 121 may be connected to the nozzle part 110 (e.g., via the protrusion 123). The rotation member 121 may extend along the reference direction D. The rotation member 121 may be shaped such that a portion thereof is insertable into an area of the nozzle part 110 (e.g., the rotation member 121 may be contiguous with the protrusion 123).

The protruding member 122 may protrude from the rotation member 121 radially outward. The protruding member 122 configured to be inserted into the guide part 130. The protruding member 122 inserted into the guide part 130 may cause the operations of the rotation member 121 and the guide part 130 to interwork with each other.

The guide part 130 may include a guide hole 131 (e.g., the guide hole 131 may be formed in the guide part 130). The guide hole 131 may be configured such that the protruding member 122 may be inserted thereinto. The guide hole 131 may include a first hole area 131a. The first hole area 131a may have a shape that is inclined in the circumferential direction from the reference direction (e.g., inclined to have components in both the circumferential and reference directions). For example, the first hole area 131a may extend in a spiral shape that along the reference direction D. Because the first hole area 131a is inclined in the circumferential direction from the reference direction D, if the rotation part 120 is guided the reference direction D and/or the opposite direction to the reference direction D, the rotation part 120 may be guided in the circumferential direction at the same time.

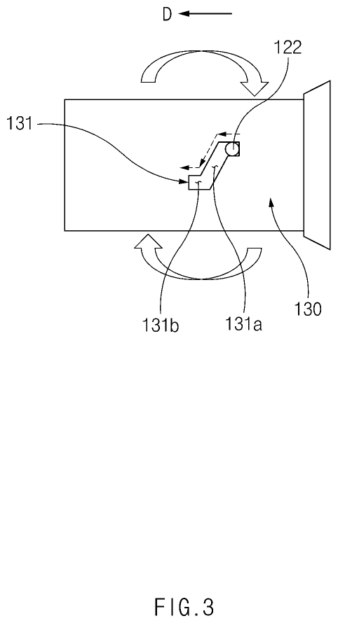

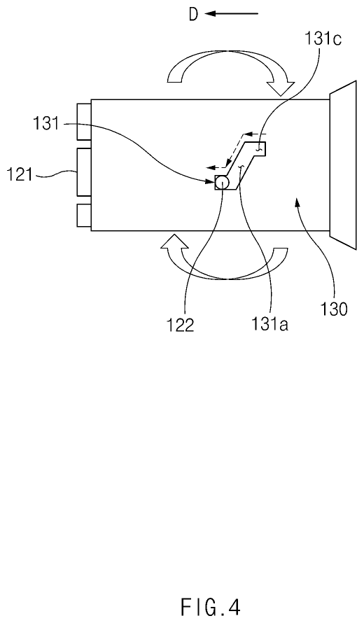

FIG. 3 is a view illustrating a state in which the protruding member 122 is disposed in a third hole area. FIG. 4 is a view illustrating a state in which the protruding member 122 is disposed in the second hole area. The guide hole 131 may include a second hole area 131b (FIG. 3) and a third hole area 131c (FIG. 4). The second hole area 131b may extend from an end of the first hole area 131a in the reference direction D (e.g., along the reference direction D). If the protruding member 122 is located at an end of the second hole area 131b in the reference direction D (e.g., as in FIG. 4), the end of the rotation part 120 in the reference direction D (e.g., an end of the rotation member 121 in the reference direction D) may extend beyond the end of the guide part 130 in the reference direction D (e.g., as shown in FIG. 4).

The third hole area 131c may extend from an end of the first hole area 131a in the opposite direction to the reference direction D (e.g., along the opposite direction to the reference direction D). If the protruding member 122 is located at an end of the third hole area 131c in the reference direction (e.g., as in FIG. 3), the end of the rotation part 120 in the reference direction D may not extend beyond the end of the guide part 130 in the reference direction D (e.g., as shown in FIG. 3).

The guide part 130 may elastically support the rotation part 120 toward the radially inner side. This may mean that the rotation part 120 may be widened toward the radially outer side in the case of no support by the guide part 130. As an example, the guide part 130 may elastically support the end of the rotation part 120 in the reference direction D.

If the rotation part 120 is moved in the reference direction D and the end of the rotation part 120 in the reference direction D is located in the reference direction D with respect to the end of the guide part 130 in the reference direction D, the end of the rotation part 120 in the reference direction D may be located radially outward with respect to the end of the rotation part 120 in the opposite direction to the reference direction D. This may be a state for the nozzle being separated from the receptacle R. If the protruding member 122 is located at an end of the second hole area 131b in the reference direction D, the end of the rotation part 120 in the reference direction may be located in the reference direction D with respect to the end of the guide part 130 in the reference direction D, and this may mean that the end of the rotation part 120 in the reference direction D is not supported by the guide part 130. Accordingly, the end of the rotation part 120 in the reference direction D may be moved radially outward (e.g., dashed arrows in FIG. 2).

A plurality of rotation parts 120 may be formed. As illustrated in FIG. 5, the plurality of rotation parts 120 may be spaced apart from each other along the circumferential direction. A plurality of protruding members 122 may be formed. The plurality of protruding members 122 may be formed to be disposed in the plurality of rotation parts 120. The number of guide holes 131 may correspond to the number of the protruding member 122.

The fluid filling nozzle according to the first example of the present disclosure may further include a cover part 140. The cover part 140 may be coupled to an outer side of the guide part 130 to surround the guide part 130. A length of the cover part 140 along the reference direction D may be larger than a length of the guide part 130 along the reference direction D.

Hereinafter, an operation of the fluid filling nozzle according to the first example of the present disclosure will be described in detail based on the above-described contents. This may be understood that the state of FIG. 1 is changed to the state of FIG. 2. Then, the protruding member 122 may be located in the third hole area 131c.

First, to separate the fluid filling nozzle from the receptacle R in a state, in which ice is formed between the fluid filling nozzle and the receptacle R, the guide part 130 is moved in the opposite direction to the reference direction D. The guide part 130 may be moved as the cover part 140 is moved. As the guide part 130 is moved in the opposite direction to the reference direction D, the protruding member 122 may be moved from the third hole area 131c to the first hole area 131a.

Even if the protruding member 122 is in (e.g., enters) the first hole area 131a, the guide part 130 may continue to be moved (e.g., still be able to and/or have room to move) in the opposite direction to the reference direction D. If protruding member 122 is moved along the first hole area 131a, the rotation part 120 may be rotated along the circumferential direction. In this process, the ice between the receptacle R and the fluid filling nozzle may be disrupted.

If the protruding member 122 enters the second hole area 131b, the end of the rotation member 121 in the reference direction may protrude in the reference direction D with respect to the guide part 130. The end of the rotation member 121 in the reference direction D may be moved to the radially outer side, and coupling with the receptacle R may be released.

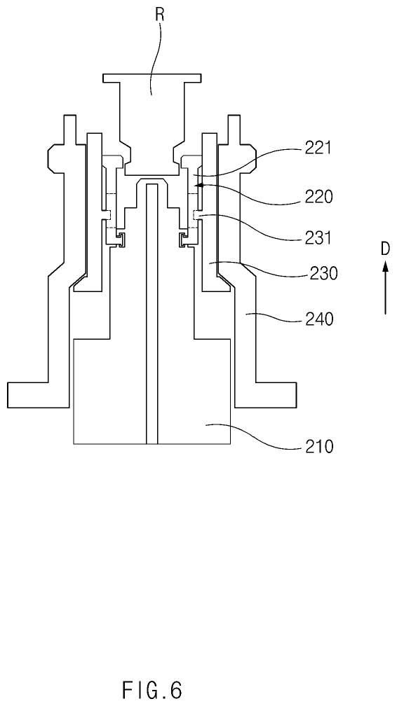

FIG. 6 is a view illustrating the fluid filling nozzle according to a second example of the present disclosure. Hereinafter, the fluid filling nozzle according to the second example of the present disclosure will be described. The fluid filling nozzle according to the second example is different from the fluid filling nozzle according to the first example in disposition of a protruding member 231 (e.g., protrusion, corresponding to the protruding member 131) and a guide groove. The same or corresponding configurations as those of the fluid filling nozzle according to the first example will be denoted by the same or corresponding reference numerals, and a detailed description thereof will be omitted.

The fluid filling nozzle according to the second example of the present disclosure may include a nozzle part 210 (corresponding to the nozzle part 110), a rotation part 220 (corresponding to the rotation part 120), a guide part 230 (corresponding to the guide part 130), and a cover part 240 (corresponding to the guide part 140). The guide part 230 may include the protruding member 231. The protruding member 231 may protrude toward the rotation part 220. The rotation part 220 may include a rotation member 221 (corresponding to the rotation member 121) and a guide hole (not illustrated). The rotation member may be connected to the nozzle part 210 and may extend along the reference direction D. The guide hole may be formed in the rotation member 221. The protruding member 231 may be inserted into the guide hole.

It may be understood that the disposition of the protruding member and the guide groove is opposite to those of the fluid filling nozzle of the first example, in the fluid filling nozzle according to the second example.

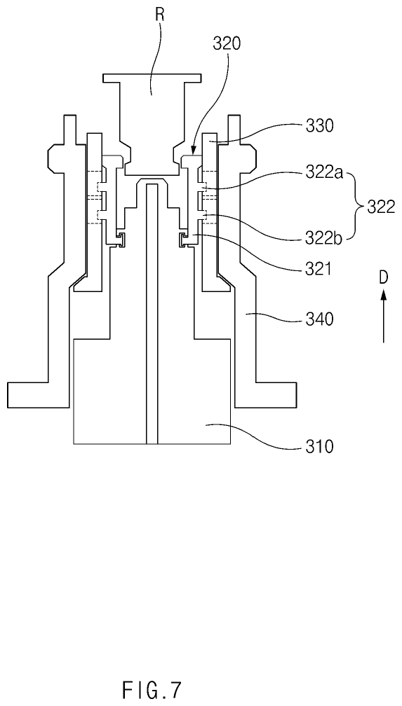

FIG. 7 is a view illustrating a fluid filling nozzle according to a third example of the present disclosure. Hereinafter, the fluid filling nozzle according to the third example of the present disclosure will be described with reference to FIG. 7. The fluid filling nozzle according to the third example is different from the fluid filling nozzle according to the first example in the disposition of the protruding member. The same or corresponding configurations of the fluid filling nozzle according to the first example will be denoted by the same or corresponding reference numerals, and a detailed description thereof will be omitted.

The fluid filling nozzle according to the third example of the present disclosure may include a nozzle part 310 (e.g., corresponding to the nozzle part 110), a rotation part 320 (e.g., corresponding to the rotation part 120), a guide part 330 (e.g., corresponding to the guide part 130), and a cover part 340 (e.g., corresponding to the cover part 140). The rotation part 320 may include a rotation member 321 (e.g., corresponding to the rotation member 121) and a protruding member 322. The protruding member 322 may include a first protruding member 322a and a second protruding member 322b. Two protruding members 322 are shown in the example and discussed, but any number of protruding members 322 and arrangements thereof may be contemplated. The second protruding member 322b may be located on a side of the first protruding member 322a in the reference direction D.

The guide hole may include a first guide hole (not illustrated) and a second guide hole (not illustrated). The first guide hole may be configured such that the first protruding member 322a is inserted thereinto. The second guide hole may be configured such that the second protruding member 322b is inserted thereinto, and may be located on a side of the first guide hole in the reference direction D.

However, it is apparent that a plurality of protruding members, including the first protruding member 322a and the second protruding member 322b, may be formed in one rotation part 320, and the disposition thereof may be variously changed in a range that may be easily derived by an ordinary person in the art.

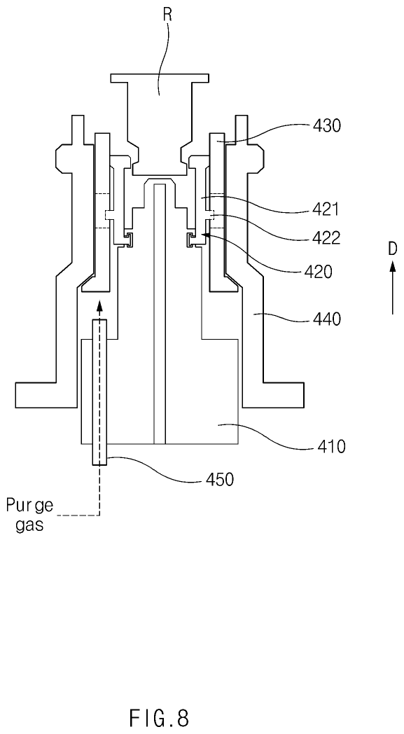

FIG. 8 is a view illustrating a fluid filling nozzle according to a fourth example of the present disclosure. Hereinafter, the fluid filling nozzle according to the fourth example of the present disclosure will be described. The fluid filling nozzle according to the fourth example is different from the fluid filling nozzle according to the first example in presence of a discharge part 450. The same or corresponding configurations of the fluid filling nozzle according to the first example will be denoted by the same or corresponding reference numerals, and a detailed description thereof will be omitted.

The fluid filling nozzle according to the fourth example of the present disclosure may include a nozzle part 410 (e.g., corresponding to the nozzle part 110), a rotation part 420 (e.g., corresponding to the rotation part 120), a guide part 430 (e.g., corresponding to the guide part 130), and a cover part 440 (e.g., corresponding to the cover part 140). The rotation part 420 may include a rotation member 421 (e.g., corresponding to the rotation member 121) and a protruding member 422 (e.g., corresponding to the protruding member 122).

The fluid filling nozzle according to the fourth example may further include the discharge part 450. The discharge part 450 may be configured to discharge a purging gas toward a space between the guide part 430 and the rotation part 420. The purging gas may be nitrogen, but the present disclosure is not limited thereto. The discharge part 450 may be disposed between the cover part 440 and the nozzle part 410.

Because the fluid filling nozzle according to the fourth example may discharge the purging gas toward the space between the guide part 430 and the rotation part 420, ice that may be formed between the guide hole and the protruding member 422 may be solved. Accordingly, the ice between the nozzle and the receptacle R may be disrupted more conveniently.

A fluid filling nozzle herein solve a problem of ice in a space between a receptacle and a nozzle.

The fluid filling nozzle may include a nozzle part that guides a fluid that is introduced into an interior thereof along a reference direction, a rotation part coupled to a side of the nozzle part in the reference direction such that an end thereof in an opposite direction to the reference direction is rotatable, and a guide part, in which the nozzle part is disposed in an interior thereof, and that guides the nozzle part such that the nozzle part is moved along the reference direction and the opposite direction thereto, the guide part is formed such that a portion of the rotation part is engaged therewith, and the rotation part is rotated when the guide part is moved forwards and rearwards.

For a circumferential direction defined with reference to an imaginary circle, a center of which is the reference direction, the rotation part may be configured such that an end thereof in the reference direction is moved along the circumferential direction when the guide part is moved in the opposite direction to the reference direction.

In another example, when a radial direction is defined with reference to the imaginary circle, the center of which is the reference direction, the rotation part may include a rotation member connected to the nozzle part and extending along the reference direction, and a protruding member protruding from the rotation member toward a radially outer side, the guide part may include a guide hole configured such that the protruding member is inserted thereinto, and the guide hole may include a first hole area having a spiral shape inclined in the circumferential direction with respect to the reference direction.

In another example, the guide hole may include a second hole area extending from an end of the first hole area in the reference direction along the reference direction, and a third hole area extending from an end of the first hole area in the opposite direction to the reference direction along the opposite direction to the reference direction.

In another example, when the protruding member is located at an end of the second hole area in the reference direction, an end of the rotation part in the reference direction may be located in the reference direction with respect to an end of the guide part in the reference direction.

In another example, the guide part may elastically support the rotation part toward a radially inner side.

In another example, the guide part may elastically support an end of the rotation part in the reference direction, and when the rotation part is moved in the reference direction and the end of the rotation part in the reference direction is located in the reference direction with respect to the end of the guide part in the reference direction, the end of the rotation part in the reference direction may be located on the radially outer side with respect to the opposite direction of the rotation part to the reference direction.

In another example, the fluid filling nozzle may further include a cover part coupled to an outer side of the guide part and that surrounds the guide part, a length of the cover part in the reference direction may be larger than a length of the guide part in the reference direction.

In another example, the fluid filling nozzle may further include a discharge part that discharges a purging gas toward a space between the guide part and the rotation part.

In another example, the fluid filling nozzle may further include a cover part coupled to an outer side of the guide part and that surrounds the guide part, and the discharge part may be disposed between the cover part and the nozzle part.

In another example, a plurality of rotation parts may be provided, and the plurality of rotation parts may be spaced apart from each other along the circumferential direction.

In another example, a plurality of protruding members may be provided, and the number of guide holes may correspond to the number of protruding members.

In another example, the protruding member may include a first protruding member, and a second protruding member located on a side of the protruding member in the reference direction, and the guide hole may include a first guide hole, into which the first protruding member is inserted, and a second guide hole, into which the second protruding member is inserted, and located on a side of the first guide hole in the reference direction.

In another example, the guide part may include a protruding member protruding toward the rotation part, the rotation part may include a rotation member connected to the nozzle part and extending along the reference direction, and a guide hole formed in the rotation member and extending along the reference direction, and the guide hole may include a first hole area having a shape that is inclined along the reference direction in the circumferential direction.

In another example, the guide hole may include a second hole area extending from an end of the first hole area in the reference direction along the reference direction, and a third hole extending from an end of the first hole area in the opposite direction to the reference direction along the opposite direction to the reference direction.

According to the present disclosure, because the ice between the receptacle and the nozzle is disrupted through rotation, an inconvenience of a user due to the ice may be alleviated.

The above description is a simple exemplary description of the technical spirits of the present disclosure, and thus, an ordinary person in the art, to which the present disclosure pertains, will make various corrections and modifications while not deviating from the essential characteristics of the present disclosure. Accordingly, the examples disclosed in the present disclosure are not for limiting the technical spirits of the present disclosure but for describing them, and the scope of the technical sprits of the present disclosure is not limited by the examples. The protection range of the present disclosure should be construed by the following claims, and all the technical spirits within the equivalent range should be construed as falling within the scope of the present disclosure.

What is claimed is:

1. A fluid filling nozzle comprising:
a nozzle configured to direct a fluid from an interior of the nozzle along a reference direction;
a rotation part coupled to a side of the nozzle so as to be able to rotate around the nozzle while coupled thereto; and
a guide surrounding the nozzle and configured to guide the nozzle to move parallel or antiparallel to the reference direction,
wherein the guide is configured to engage with a portion of the rotation part so as to cause the rotation part to be rotated based on the guide being moved forwards or rearwards.

2. The fluid filling nozzle of claim 1, wherein an end of the rotation part in the reference direction is configured to be rotated in a circumferential direction based on the guide being moved antiparallel to the reference direction, wherein the circumferential direction is a direction parallel to a circumference of circle centered around the interior of the nozzle and in a plane perpendicular to the reference direction.

3. The fluid filling nozzle of claim 2, wherein the rotation part includes:
a rotation member connected to the nozzle and extending along the reference direction; and
a protrusion protruding radially outward from the rotation member,
wherein a guide hole is formed in the guide, and wherein:
the guide hole is configured to receive the protrusion inserted thereinto, and
the guide hole comprises a first hole area having a shape inclined from the reference direction in the circumferential direction with respect to the reference direction.

4. The fluid filling nozzle of claim 3, wherein the guide hole includes:
a second hole area extending parallel to the reference direction and from an end of the first hole area in the reference direction; and
a third hole area extending antiparallel to the reference direction and from another end of the first hole area in an opposite direction to the reference direction.

5. The fluid filling nozzle of claim 4, wherein, the rotation part is configured so that location of the protrusion in the second hole area causes an end of the rotation part to extend, in the reference direction, beyond an end of the guide.

6. The fluid filling nozzle of claim 4, wherein the guide is configured to elastically support the rotation part radially inward.

7. The fluid filling nozzle of claim 6, wherein the guide is configured to elastically support a first end of the rotation part radially inward, and
wherein, the rotation part is configured so that movement of the rotation part in the reference direction, such that the first end of the rotation part extends beyond the end of the guide in the reference direction, causes the first end of the rotation part to extend radially outward with respect a second end of the rotation part, wherein the second end is opposite to the first end is in the reference direction.

8. The fluid filling nozzle of claim 1, further comprising:
a cover coupled to an outer side of the guide and configured to surround the guide, wherein a length of the cover in the reference direction is greater than a length of the guide in the reference direction.

9. The fluid filling nozzle of claim 1, further comprising:
a discharge part configured to discharge a purging gas toward a space between the guide and the rotation part.

10. The fluid filling nozzle of claim 9, further comprising:
a cover part coupled to an outer side of the guide and configured to surround the guide, wherein the discharge part is disposed between the cover part and the nozzle.

11. The fluid filling nozzle of claim 2, comprising a plurality of rotation parts comprising the rotation part, and
wherein the plurality of rotation parts are spaced apart from each other in the circumferential direction.

12. The fluid filling nozzle of claim 3, wherein the rotation part comprises a plurality of protrusions comprising the protrusion,
wherein a plurality of guide holes, comprising the guide hole, is formed in the guide, and
wherein a number of the guide holes corresponds to a number of the protrusions.

13. The fluid filling nozzle of claim 12, wherein the plurality of protrusions comprise:
a first protrusion and a second protrusion, wherein the first protrusion and the second protrusion are arranged on a side of the rotation member in the reference direction, and
wherein the guide hole includes:
a first guide hole, configured to accept the first protrusion, and a second guide hole, configured to accept the second protrusion, wherein the first guide hole and the second guide hole are formed in a side of the guide in the reference direction.

14. The fluid filling nozzle of claim 3, wherein the guide comprises a protrusion protruding toward the rotation part,
wherein the rotation part comprises a rotation member connected to the nozzle and extending along the reference direction, wherein a guide hole is formed in the rotation member and extends parallel to the reference direction, and
wherein the guide hole comprises a first hole area having a shape that is inclined in the circumferential direction from the reference direction.

15. The fluid filling nozzle of claim 14, wherein the guide hole comprises:
a second hole area extending parallel to the reference direction and from an end of the first hole area in the reference direction; and
a third hole extending antiparallel to the reference direction and from another end of the first hole area in an opposite direction to the reference direction.
